(19) United States
(12) Patent Application Publication
(10) Pub. No.: US 2013/0202909 A1
(43) Pub. Date: Aug. 8, 2013

(54) METHOD OF PRODUCING METAL NANOPARTICLES

(71) Applicant: LG Chem, Ltd., Seoul (KR)

(72) Inventors: Young Chang Byun, Daejeon (KR); Jung Hyun Seo, Daejeon (KR); Jae Hoon Chae, Daejeon (KR); In Hyoup Song, Daejeon (KR); Kwang Ho Song, Gyeonggi-do (KR)

(73) Assignee: LG Chem, Ltd., Seoul (KR)

(21) Appl. No.: 13/759,783

(22) Filed: Feb. 5, 2013

(30) Foreign Application Priority Data
Feb. 6, 2012 (KR) 10-2012-0011788
Jan. 18, 2013 (KR) 10-2013-0005983

(51) Int. Cl. B22F 9/24; C09D 11/00

(52) U.S. Cl. CPC B22F 9/24; C09D 11/52
USPC 428/546; 75/370

(57) ABSTRACT

Provided is a method of producing metal nanoparticles. Preferably, the method of producing metal nanoparticles includes preparing a reaction solution by adding a reducing agent solution to a dispersing agent solution, and simultaneously putting a metal precursor solution and the reducing agent solution into the reaction solution and mixing the resulting mixture. Large amounts of metal nanoparticle powder having a uniform particle diameter may be easily prepared.

### BACKGROUND

1. Field of the Invention

The present invention relates to a method of producing metal nanoparticles.

2. Discussion of Related Art

Recently, following the trends of smaller and higher-density electronic members, there is a demand for metal patterning of a thin film through an ink jet or forming a fine interconnection on a substrate, and to realize this, it is necessary to form a conductive ink with nano-sized metal particles having a uniform shape and narrow particle size distribution and exhibiting excellent dispersibility. That is, the necessity to effectively produce metal nanoparticles has also increased with the above-described demand.

As a method of producing metal nanoparticles, there are three main types of methods, including chemical synthesis methods, mechanical production methods and electrical production methods.

In the mechanical production methods of grinding a material using mechanical power, it is difficult to synthesize high-purity particles by mixing impurities in a process, and uniform nano-sized particles are not produced.

The electrical production methods are mainly executed by electrolysis. In this case, this method has disadvantages of a long production time, a low efficiency due to a low concentration of metal particles in an aqueous solution, a high production cost, and difficulty in mass production.

The chemical synthesis methods are largely divided into a vapor method and a solution method (colloid method). Since the vapor method using a plasma or evaporation method needs expensive equipment, the solution method capable of synthesizing uniform particles at a low cost is being mainly used.

As the chemical solution method, 1) an organic reduction method (reduction method) using organic reducing agents such as glucose and ascorbic acid and 2) a polyol synthesis method of performing reduction using ethyleneglycol may be used.

The method of producing metal nanoparticles by organic reduction is a method of dissociating a metal compound in water and producing hydrosol-type metal particles using a reducing agent and a surfactant.

Meanwhile, in the polyol synthesis method, formation of nano-sized particles through reduction of a metal salt includes the following four operations:

a) reduction of metal ions into metal atoms;

b) aggregation of the metal atoms in the form of nuclei;

c) growth of the nuclei into metal nanoparticles; and

d) stabilization of the metal nanoparticles by a stabilizer.

In the initial operation, a metal salt, which is a precursor material, is dissolved in a liquid polyol, the dissolved salt is reduced by the polyol, and nano-sized particles are produced from the solution through nucleation and growth of metal particles. Afterward, metal nanoparticles are stabilized by a stabilizer.

In the polyol synthesis method, in a mechanism polyol process for forming metal nanoparticles, the liquid polyol serves as a solvent for dissolving a metal precursor and a reducing agent, and thus a reaction may be executed without adding a separate reducing agent. In addition, there may be advantages in that a high concentration of nano-sized metal colloids may be produced, a particle size is uniform, a degree of dispersion is high, and a separate reducing agent is not separately used by reactions.

Due to the advantages as mentioned above, today, the polyol synthesis method is used as a main method for producing nanoparticles.

Aside from those relating to the production of metal nanoparticles described above, further detailed conventional art is as follows.

Non-Patent Literature 1 discloses methods of producing nano-sized platinum-group metal colloids having a stable dispersion state using a polyol process chemical reduction method, and producing silver nanowires having a one-dimensional structure using seeds and a water-soluble polymer [Kim, Sugon, “Synthesis of Nano-sized Metal Colloids & Silver nanowires of 1-Dimensional Structure by Polyol Process with Seeds and Water-soluble polymers”, Master's Thesis, Han-yang University, 2005.2.].

Patent Literature 1 (Korean Patent Application Publication No. 10-2008-0035315 (Apr. 23, 2008)) discloses a method of producing silver nanoparticles, and more particularly, a method of producing silver nanoparticles, which includes an operation of producing a first solution including a metal reducing agent by preparing a solution including a precursor of a metal reducing agent, a dispersing agent and a polar solvent and increasing a temperature; an operation of preparing a second solution including a silver precursor and a polar solvent; and an operation of cooling the first solution to room temperature, adding the second solution, to the first solution, raising of temperature of the mixture. According to the above method, silver nanoparticle powder having a small and uniform particle size may be easily produced, and thus can be useful in mass production.

Patent Literature 2 (Korean Patent No.754326 (Aug. 27, 2007)) discloses a method of producing silver nanoparticles in which uniform-sized particles having excellent dispersion stability are mass-produced with a high yield in the presence of a polar solvent, and a polyacid is used as a stabilizer even with a smaller amount than when another polymer is used to control a particle size and have dispersion stability, and nanoparticles produced thereby.

In the method of producing metal nanoparticles by a polyol process mainly used in the conventional art, a production cost of metal nanoparticles is excessively increased using a large amount of materials for forming a film such as an expensive PVP film (capping agent) to control a particle size, but there is a limit to controlling the particle size. In addition, the polyol synthesis method has problems of a large difference in particle size depending on a synthesized amount, and a low yield because of difficulty in controlling homogeneous nucleation and a growth rate in massive synthesis.

In further detail, the polyol method required high temperature to maximize reducing power of ethyleneglycol, and a large amount of PVPs for controlling a particle size. Non-Patent Literature 2 (Xia, Y. et al, Chem. Eur. J. 2005. 11, 454-463) discloses that spherical silver nano-particles can be obtained when the amount of PVPs is 10 times a mol number of a silver ion. Since such a maximized amount of PVPs acts as a factor such that the synthesis of metal particles in a large amount and at a high concentration is impossible, there is a demand for a method to reduce the amount of PVPs.

In addition, among reduction methods using an organic reducing agent, since ascorbic acid reduces silver ions at room temperature, it is difficult to control particles. Since glucose has a very low solubility in water, a large amount of polar solvents is needed to adjust a concentration based on silver ions, and thus it is difficult to synthesize high-concentration particles. Because of that, the conventional silver particle synthesis method is only possible to execute at a low concentration (>0.05 M), and an amount of silver nanao-particles obtained in one batch is limited. That is, metal nanoparticles having a uniform size may be formed when a concentration of metal compounds is mM or less, and an amount of metal nanoparticles yielded thereby is limited. Therefore, to obtain metal nanoparticles having a uniform size with an amount in the unit of grams (g) or more, a reaction vessel having at least 1000 L was required. This is the major limitation to effective mass production. In addition, this is a factor that further decreases a yield due to un-reacted materials after the end of the reaction and loss of a large amount of particles in separation of the produced metal nanoparticles. Moreover, when the obtained metal nanoparticles are redispersed in a solvent to be applied to various regions, dispersion stability is important. However, the method known in the conventional art has a very low dispersity.

Patent Literature 3 (Korean Patent Application Publication No. 2008-0017838) discloses a method of producing silver nanoparticles including controlling a pH of a dispersion solution to 4 to 11 by adding a dispersing agent to a silver salt aqueous solution, and performing reduction by adding a reducing agent. This method needs to be improved since various sizes of silver seeds are produced when the reducing agent is put into a highly concentrated silver salt aqueous solution, and silver nanoparticles having wide particle size distribution are produced.

### SUMMARY OF THE INVENTION

The present invention is directed to providing a method of producing metal nanoparticles having a uniform particle diameter by preparing a reaction solution by adding a reducing agent solution to a dispersing agent solution and simultaneously putting a metal precursor solution and the reducing agent solution into the reaction solution and mixing the resulting mixture.

The present invention is directed to providing a method of producing metal nanoparticles having a uniform particle diameter.

In addition, the present invention is directed to providing metal nanoparticles having a uniform particle diameter produced by the above method and a conductive ink using the same.

One aspect of the present invention provides a method of producing metal nanoparticles, including preparing a reaction solution by adding a reducing agent solution (B) to a dispersing agent solution (C), and simultaneously putting a metal precursor solution (A) and the reducing agent solution (B) into the reaction solution and mixing the resulting mixture.

Hereinafter, a method of producing metal nanoparticles according to the present invention will be described in further detail.

First, a reaction solution is prepared by adding a reducing agent solution (B) to a dispersing agent solution (C).

In the present invention, the dispersing agent solution (C) is prepared by dissolving a dispersing agent in a solvent. The dispersing agent may be any one of those used in the production of metal nanoparticles, and may be at least one selected from the group consisting of polyvinylpyrrolidone (PVP), cetyltrimethylammonium bromide (CTAB), sodium dodecyl sulfate (SDS) and sodium carboxymethyl cellulose (Na-CMC). The solvent may be, but is not limited to, at least one polar solvent selected from the group consisting of water, alcohol, polyol, dimethylformanide (DMF), and dimethylsulfoxide (DMSO). The alcohol may be, but is not limited to, at least one selected from the group consisting of methanol, ethanol, 1-propanol, 2-propanol, 1-butanol, 2-butanolisobutanol, hexanol and octanol.

The polyol may be, but is not limited to, at least one selected from the group consisting of glycerol, glycol, ethylene glycol, diethylene glycol, triethylene glycol, butanediol, tetraethylene glycol, propyleneglycol, polyethylene glycol, polypropyleneglycol, 1,2-pentadiol and 1,2-hexadiol.

The dispersing agent may be used at 1 to 60 parts by weight, and preferably 10 to 55 parts by weight, with respect to 100 parts by weight of the metal precursor. When the dispersing agent is used at less than 1 part by weight, the produced nanoparticles are agglomerated, and when the dispersion agent is used at more than 60 parts by weight, mixing is performed slowly due to an increased viscosity, and thus nanoparticles having a large particle diameter are produced.

A reaction solution having a pH of 8 to 13 is prepared by adding the reducing agent solution (B) to the dispersing agent solution (C) prepared as described above.

In the present invention, the reducing agent solution (B) is prepared by dissolving a reducing agent and a strong base in a solvent. The reducing agent may be, but is not limited to, at least one selected from the group consisting of NaBH₄, LiBH₄, tetrabutylammonium borohydride, N₂H₄, glycol, glycerol, dimethylformamide, tannic acid, citrate and glucose. The reducing agent may be used with the strong base to completely perform reduction, and the strong base may be, but is not limited to, at least one of sodium hydroxide, potassium hydroxide, lithium hydroxide, rubidium hydroxide, cesium hydroxide, calcium hydroxide, strontium hydroxide and barium hydroxide. If the strong base is not used, the reduction is performed only 30 to 50%. In addition, the solvent used for the reducing agent solution may be a solvent defined according to the dispersing agent solution.

As the reaction solution is prepared to have a pH of 8 to 13 as described above, a particle diameter of the produced nanoparticles may be controlled.

In the present invention, the metal precursor solution (A) is prepared by dissolving a metal precursor in a solvent. The metal precursor may include at least one selected from the group consisting of gold, silver, copper, nickel, palladium and platinum, and is preferably, but not limited to, at least one compound selected from the group consisting of AgNO₃, AgBF₄, AgPF6, Ag₂O, CH₃COOAg, AgCF₃SO₃, AgClO₄, AgCl, Ag₂SO₄, CH₃COCH═COCH₃Ag, Cu(NO₃)₂, CuCl₂, CuSO₄, C₅H₇CuO₂, NiCl₂, Ni(NO₃)₂, NiSO₄, HAuCl₄ Pd(OAc)₂, Pd (NO₃)₂, PdCl₂, H₂PtCl₆, PtCl₄ and PtCl₂. The solvent may be a solvent defined according to the dispersing agent solution.

The reducing agent used herein is N₂H₄, which may be used at 0.1 to 0.5 molar parts, and preferably, 0.15 to 0.4 molar parts, based on 1 molar parts of the metal precursor. When the reducing agent is less than 0.1 molar parts, un-reacted metals are increased, and when the reducing agent is more than 0.5 molar parts, particle size distribution is wider.

Afterward, a metal precursor solution and a reducing agent solution are simultaneously put into the reaction solution, and mixed together. That is, when the metal precursor solution (A) and the reducing agent solution (B) are simultaneously put into the dispersing agent solution and stirred, metal nanoparticles having a uniform particle diameter are produced. Here, an input rate of the metal precursor solution (A) and the reducing agent solution (B) may be controlled to 0.1 to 100 ml/min, and preferably 0.2 to 50 ml/min. When the rate is less than 0.1 ml/min, it takes too long to input the solutions (leading to a total reaction time that is too long), and when the rate is more than 100 ml/min, the particle size distribution does not get any narrower.

The reaction may be performed at 0 to 50° C., and preferably 10 to 35° C.

The metal nanoparticles produced as described above have a coefficient of variation (CV), which represents particle size distribution, of 0.05 to 0.25, and therefore it means that the particle size distribution is uniform. Moreover, the metal nanoparticles may have an average particle diameter of approximately 30 to 200 nm (preferably approximately 35 to 150 nm), and may serve as a conductive ink.

### BRIEF DESCRIPTION OF THE DRAWINGS

The above and other objects, features and advantages of the present invention will become more apparent to those of ordinary skill in the art by describing in detail exemplary embodiments thereof with reference to the adhered drawings, in which:

FIG. 1 is a diagram explaining production of silver nanoparticles according to an exemplary embodiment of the present invention;

FIG. 2 is a field emission scanning electron microscopy (FESEM) image of silver nanoparticles produced according to Example 1 of the present invention;

FIG. 3 is an FESEM image of silver nanoparticles produced according to Example 2 of the present invention; and

FIG. 4 is an FESEM image of silver nanoparticles produced according to Comparative Example 1 of the present invention.

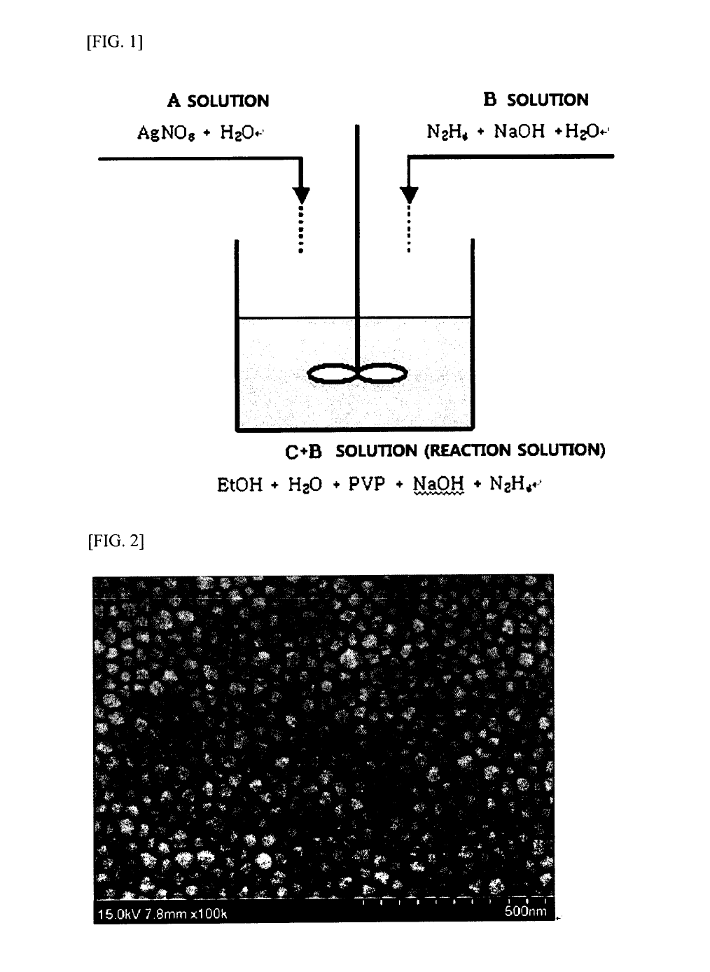

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the related art to embody and practice the present invention.

Although the terms first, second, etc. may be used to describe various elements, these elements are not limited by these terms. These terms are only used to distinguish one element from another. For example, a first element could be termed a second element, and, similarly, a second element could be termed a first element, without departing from the scope of exemplary embodiments. The term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of exemplary embodiments. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, components and/or groups thereof, but do not preclude the presence or addition of one or more other features, integers, steps, operations, elements, components and/or groups thereof.

With reference to the appended drawings, exemplary embodiments of the present invention will be described in detail below. In order to aid in understanding the present invention, like numbers refer to like elements throughout the description of the figures, and the description of the same elements will be not reiterated.

Hereinafter, a curable composition according to the present invention will be described in further detail with reference to Examples according to the present invention, but the scope of the present invention is not limited to the following Examples.

### EXAMPLE 1

### Production of Silver Nanoparticles

An AgNO₃ solution was prepared by dissolving 40 g (0.236 mol) of AgNO₃ in 40 g of water [metal precursor solution (A)].

A hydrazine solution was prepared by dissolving 2.95 g (0.059 mol) of hydrazine monohydrate (N₂H₄.H₂O) in 45 g of water and mixing 9.44 g of NaOH with the resulting solution [reducing agent solution (B)].

A PVP solution was prepared by dissolving 20 g of PVP (Junsei, MW=40,000) in 20 g of water and 40 g of ethanol [dispersing agent solution (C)].

A reaction solution was prepared by putting the dispersing agent solution (C) into a beaker (reaction vessel), and adding the reducing agent solution (B) thereto to adjust the pH to 11.8, and the metal precursor solution (A) and the reducing agent solution (B) were simultaneously put into the reaction solution at a rate of 2 ml/min, with stirring at 20° C.

Here, the reaction was performed for approximately 24 minutes (because a volume of the metal precursor solution (A) and the reducing agent solution (B) was approximately 48 ml), and silver produced thereby had an average nanoparticle diameter of approximately 45 nm (see FIG. 2). As the particle size was measured with reference to FIG. 2, a CV of 0.18 was obtained, which was a value representing the average particle diameter and particle size distribution.

$$CV = \frac{σ ( standard deviation )}{μ ( average particle diameter )} \qquad [ Equation 1 ]$$

### EXAMPLE 2

### Production of Silver Nanoparticles

An AgNO₃ solution was prepared by dissolving 40 g (0.236 mol) of AgNO₃ in 40 g of water [metal precursor solution (A)].

A hydrazine solution was prepared by dissolving 2.95 g (0.059 mol) of hydrazine monohydrate (N₂H₄.H₂O) in 45 g of water and mixing 7.55 g of NaOH with the resulting solution [reducing agent solution (B)].

A PVP solution was prepared by dissolving 10 g of PVP (Junsei, MW=40,000) in 20 g of water and 40 g of ethanol [dispersing agent solution (C)].

A reaction solution was prepared by putting the dispersing agent solution (C) into a beaker (reaction vessel), and adding the reducing agent solution (B) thereto to adjust the pH to 10.2, and the metal precursor solution (A) and the reducing agent solution (B) were simultaneously put into the reaction solution at a rate of 2 ml/min, with stirring at 20° C.

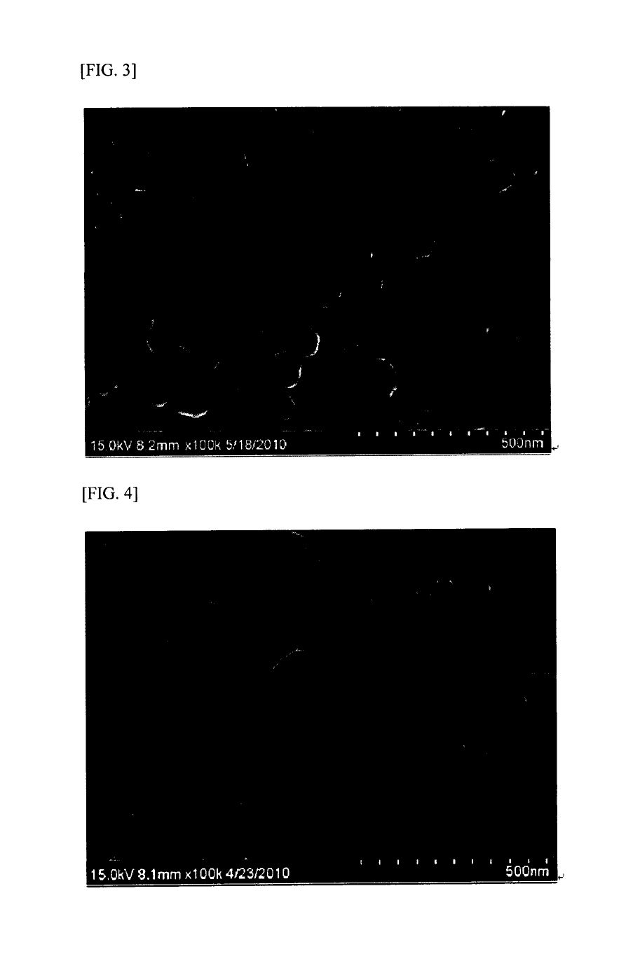

Here, the reaction was performed for approximately 24 minutes, and silver produced thereby had an average nanoparticle diameter of approximately 91 nm (see FIG. 3). As the particle size was measured with reference to FIG. 3, a CV of 0.20 was obtained.

### COMPARATIVE EXAMPLE 1

An AgNO₃ solution was prepared by dissolving 40 g (0.236 mol) of AgNO₃ in 40 g of water [metal precursor solution (A)].

A hydrazine solution was prepared by dissolving 2.95 g (0.059 mol) of hydrazine monohydrate (N₂H₄.H₂O) in 45 g of water and mixing 7.55 g of NaOH with the resulting solution [reducing agent solution (B)].

A PVP solution was prepared by dissolving 10 g of PVP (Junsei, MW=40,000) in 20 g of water and 40 g of ethanol [dispersing agent solution (C)].

A reaction solution was prepared by putting the metal precursor solution

(A) and the dispersing agent solution (C) into a beaker (reaction vessel), and the reducing agent solution (B) was put thereinto at a rate of 2 ml/min, with stirring at 20° C.

Here, the reaction was performed for approximately 24 minutes, and silver produced thereby had an average nanoparticle diameter of approximately 78 nm (see FIG. 4). As the particle size was measured with reference to FIG. 4, a CV of 0.31 was obtained.

### EXAMPLE 3

### Preparation of Conductive Ink

20 cps of a conductive ink was prepared by putting 100 g of the silver nanoparticles produced in Example 1 or 2 into diethylene glycol butyl ether acetate and an ethanol aqueous solution, and dispersing the mixture using an ultra sonicator. The conductive ink prepared as described above was printed on a circuit board by an ink jet method, thereby forming a conductive interconnection.

According to a method of producing metal nanoparticles of the present invention, large amounts of metal nanoparticle powder having a uniform particle diameter can be easily produced.

While the invention has been shown and described with reference to certain exemplary embodiments thereof, it will be understood by those skilled in the related art that various changes in form and details may be made therein without departing from the scope of the invention as defined by the appended claims.

1. A method of producing metal nanoparticles, comprising:
preparing a reaction solution by adding a reducing agent solution to a dispersing agent solution; and
simultaneously putting a metal precursor solution and the reducing agent solution into the reaction solution and mixing the resulting mixture.

2. The method according to claim 1, further comprising:
preparing a reaction solution having pH of 8 to 13 by adding a reducing agent solution to a dispersing agent solution.

3. The method according to claim 1, wherein a dispersing agent is at least one selected from the group consisting of polyvinylpyrrolidone (PVP), cetyltrimethylammonium bromide (CTAB), sodium dodecyl sulfate (SDS) and sodium carboxymethyl cellulose (Na-CMC).

4. The method according to claim 1, wherein the reducing agent solution is prepared by dissolving a reducing agent and a strong base in a solvent.

5. The method according to claim 4, wherein a reducing agent is at least one selected from the group consisting of NaBH₄, LiBH₄, tetrabutylammonium borohydride, N₂H₄, glycol, glycerol, dimethylformamide, tannic acid, citrate and glucose.

6. The method according to claim 4, wherein the strong base is at least one of sodium hydroxide, potassium hydroxide, lithium hydroxide, rubidium hydroxide, cesium hydroxide, calcium hydroxide, strontium hydroxide and barium hydroxide.

7. The method according to claim 1, wherein a metal precursor is at least one selected from the group consisting of gold, silver, copper, nickel, palladium and platinum.

8. The method according to claim 1, wherein a metal precursor is at least one compound selected from the group consisting of AgNO₃, AgBF₄, AgPF6, Ag₂O, CH₃COOAg, AgCF₃SO₃, AgClO₄, AgCl, Ag₂SO₄, CH₃COCH═COCH₃Ag, Cu(NO₃)₂, CuCl₂, CuSO₄, C₅H₇CuO₂, NiCl₂, Ni(NO₃)₂, NiSO₄, HAuCl₄ Pd(OAc)₂, Pd(NO₃)₂, PdCl₂, H₂PtCl₆, PtCl₄ and PtCl₂.

9. The method according to claim 1, wherein the dispersing agent is included at 1 to 60 parts by weight with respect to 100 parts by weight of the metal precursor.

10. The method according to claim 4, wherein the reducing agent is included at 0.1 to 0.5 molar parts with respect to 1 molar parts of the metal precursor.

11. The method according to claim 1, wherein the metal precursor solution and the reducing agent solution are simultaneously put into the reaction solution at a rate of 0.1 to 100 ml/min.

12. The method according to claim 1, wherein the mixing is performed at 0 to 50° C.

13. Metal nanoparticles having uniform particle size distribution, which are produced by the method of claim 1.

14. The metal nanoparticles according to claim 13, wherein a coefficient of variation (CV) representing particle size distribution is 0.05 to 0.25.

15. The metal nanoparticles according to claim 13, wherein an average particle diameter is 30 to 200 nm.

16. A conductive ink comprising the metal nanoparticles according to claim 13.
